(19) United States
(12) Patent Application Publication
(10) Pub. No.: US 2016/0261094 A1
(43) Pub. Date: Sep. 8, 2016

(54) DESIGNS AND ARRANGEMENTS OF ELECTRICAL POWER DISTRIBUTION UNITS FOR ATTENUATION OF MAGNETIC FIELDS

(71) Applicant: GREEN ELMF CABLES LTD., Haifa (IL)

(72) Inventors: Udi ADMATI, Haifa (IL); Shalom GREEN, Haifa (IL); Ran SAGIV, Haifa (IL)

(21) Appl. No.: 14/900,915

(22) PCT Filed: Jul. 7, 2014
(86) PCT No.: PCT/IL2014/050609

§ 371 Date: Dec. 22, 2015

(30) Foreign Application Priority Data
Jul. 8, 2013 (IL) 227278

(51) Int. Cl. H02B 1/20; H01R 25/16

(52) U.S. Cl. CPC H02B 1/205; H01R 25/162

(57) ABSTRACT

Disclosed herein are electrical power distribution units designed to substantially reduce the magnetic fields emanating from the power distribution units by using two or more bus bar elements for each electric carrying element of the bus system, and positioning each bus bar element in parallel and adjacent at least one other bus bar element carrying a different electrical phase or current direction. Various arrangements of bus bar elements are also disclosed, as well as methods of modifying conventional power distribution units to provide such bus bar arrangements of the invention, that substantially reduce the magnetic fields emanating from the bus bar systems of the units.

### TECHNOLOGICAL FIELD

This application generally relates to electrical power distribution units, such as wall-mountable and portable extension socket outlet units (power strips/bars).

### BACKGROUND

Power distribution units provide an arrangement of electrical sockets allowing multiple electrical devices to be powered from a single electrical socket. These power distribution units are usually provided in the form of wall mount units and portable extension power strips. As exemplified in FIGS. 1A and 1B, single phase power distribution units 10 usually have a power supply feed line 11, a bus bar system 14 electrically connected to the power supply feed line 11, and a plurality of electrical sockets 15 electrically connected to the bus bar system 14. The bus bar system 14 and the electrical sockets 15 are usually arranged to provide parallel electrical connection of electrical appliances (not shown) electrically connected to the power distribution unit 10. The bus bar system 14 typically includes three bus bars comprising a bus bar element 14p associated with the electrical phase of the system, a bus bar element 14g associated with the electrical ground of the system, and a bus bar element 14n associated with the electrical neutral of the system. The bus bar elements 14p, 14g and 14n, are electrically connected to respective electrical phase, ground and neutral, wires, 11p, 11g and 11n, of the power supply feed line 11. In this example, the power distribution unit 10 is connectable to the electrical power grid through an electrical plug 11e connected to the power supply feed line 11.

Typically, power distribution units 10 are enclosed inside electrically insulating housing (not shown) to prevent accidental user contact with the electrified bus bar and socket elements of the units.

Design of power distribution units usually mainly concerns selection of suitable materials and sufficient cross-section areas of the electrical conductors to enable the power distribution unit to supply desired electrical power without being damaged (e.g., due to over heating). However, the design considerations usually do not concern the magnetic fields emanating from the power distribution units during their operational use, which may be a source of interference in operation of electrical appliances (e.g., wired/wireless data communication, audio cables, medical devices, and suchlike), and may also present health hazards to persons residing near these units during their use.

FIG. 1B shows a side view of the bus bar elements 14p, 14g and 14n, of the bus bar system 14. As seen, the bus bars 14p, 14g and 14n, are typically substantially aligned in the same plane in an arbitrary order. Typically, magnetic fields emanating from the bus bars in such arrangements during their use constructively interfere with each other, which intensifies the magnitude of the overall magnetic field that is emanated from the power distribution unit 10.

There have been some attempts to attenuate magnetic fields and/or electromagnetic interferences (EMI) produced by electricity carrying elements. For example, U.S. Pat. No. 5,986,355 suggests reduction of magnetic alternating fields in a vehicle which comprises at least one electrical system having at least two elements of which at least one comprises one or more components generating and/or consuming electricity, and which are connected through at least one connecting cable in which flows a current having an alternating current component generating a low frequency magnetic field. This publication further describes use of at least one detecting element arranged to detect the alternating current component, and means for generating a compensating current with the use thereof. The compensating current flows adjacent to the connecting cable in such a way that the low frequency magnetic field is reduced or eliminated.

In another example, described in U.S. Pat. No. 7,310,242, a distribution box used for enclosing an electrical connection in an electrical wiring system is arranged to include a housing that is resistive to penetration by electromagnetic fields and a plurality of electrical conductors that form the electrical connection. A mirror plate is disposed within the housing and generates mirror currents to suppress electromagnetic fields generated by current flowing through the plurality of electrical conductors.

### GENERAL DESCRIPTION

There is a need in the art for electric power distribution units capable of suppressing magnetic fields emanating from bus bar systems of power distribution units. Power distribution units are designed to deliver significant amounts of electric power over bus bar elements of their bus bar systems to outlet sockets from which electrical loads (appliances) are supplied. The arrangement and connectivity of the bus bar elements inside a power distribution unit typically cause constructive interference of the magnetic fields emanating from the bus bar elements, such that when the unit is electrically loaded during use, magnetic fields emanating from the bus bar elements may be significantly intensified. Such undesired high magnetic fields may induce interferences in various electric devices (e.g., pacemakers, wireless devices, communication devices and wires), and cumulative exposure thereto presents health hazards (e.g., leukemia).

The inventors of the present invention have found that it is possible to significantly suppress/attenuate magnetic fields emanating from a bus bar system of a power distribution unit, by uniformly dividing the electric currents delivered through the bus bar system through a plurality of sub-bus-bar elements arranged in parallel to each other and uniformly distributed in a compact intervening fashion in a defined volume (or plane), such that each sub-bus-bar element is located adjacent at least one other sub-bus-bar element associated with electric current of a different phase or current direction.

The term intervening fashion/arrangement is used herein to refer to arrangements of electric carrying elements (e.g., bus bar or sub-bus-bar elements) wherein each element is located adjacent at least one other element associated with electric current of a different phase or current direction. For example, and without being limiting, in some embodiments at least some electric carrying elements are located between two other elements associated with electric current of a different phase or current direction, or surrounded by some number of the elements associated with electric current of a different phase or current direction.

By proper selection of the cross-sectional areas of the sub-bus-bar elements, the electric current delivered by the bus bar system is evenly distributed over the defined volume (or plane) through the sub-bus-bar elements. Each of said sub-bus-bar elements carries a predefined portion of the electric current of the specific electric phase or current direction with which the sub-bus-bar element is associated. Accordingly, each sub-bus-bar element carries a significantly smaller amount of electric current (50%, or less) relative to the total electric current of the specific electric phase or current direction with which the sub-bus-bar element is associated, such that the sub-bus-bar elements can be placed in closer proximity to each other in the defined volume.

As each sub-bus-bar element is carrying a relatively smaller amount of electric current, the intensity of the magnetic filed emanated therefrom, when electrically loaded, is also relatively smaller, such that the intervening arrangement of the sub-bus-bar elements in close proximity to each other, such that each sub-bus-bar element is located adjacent at least one other sub-bus-bar element associated with electric current of another phase or another direction causing destructive interference of the magnetic fields emanating from the sub-bus-bar elements, substantially attenuates the intensity of the overall (i.e., obtained by summation of all magnetic moments) magnetic field emanated from the bus bar system of the power distribution unit.

To this end, the present invention in some of its embodiments provides arrangements and designs to substantially suppress magnetic fields emanating from power distribution units. This is achieved by implementing each electricity carrying bus bar (e.g., phase and neutral bus bars, and/or electrical positive and negative bus bars) by at least two sub-bus-bar elements electrically connected to each other, and arranging the bus bar system such that each sub-bus-bar and bus bar element is located adjacent at least one other sub-bus-bar or bus bar element associated with electric current associated with a different phase or current direction (e.g., opposite direction). As will be exemplified hereinbelow, the sub-bus-bar and bus bar elements may be arranged in parallel to each other aligned in an intervening fashion in a defined plane, or uniformly distributed in an intervening fashion in a defined volume.

For example and without being limiting, in some embodiments a conventional bus bar system of a standard power distribution unit is modified by adding at least two sub-bus-bars to the original bus bar system e.g., aligned in parallel in the same plane (or in a parallel plane) of the bus bars of the original system. One of the added sub-bus-bar elements is electrically connected to the bus bar element carrying the electrical phase of the system, while the other sub-bus-bar element is electrically connected to the bus bar element carrying the electrical neutral of the system, and the sub-bus-bar elements are positioned in parallel to the original bus bar elements of the bus bar system such that each bus bar and sub-bus-bar element of the bus bar system is located adjacent at least one other sub-bus-bar or bus bar element associated with an electrical current of a different phase or current direction.

In another non-limiting example the bus bar system is arranged such that each bus bar and/or sub-bus-bar element carrying an electrical phase is located adjacent at least one element carrying an electrical neutral, and each bus bar and/or sub-bus-bar element carrying an electrical neutral is located adjacent at least one element carrying an electrical phase. In this way, the magnetic fields emanating from the bus bar elements and from the sub-bus-bar elements destructively interfere with each other such that the magnitude of overall magnetic field emanated from the power distribution unit during its operation is substantially suppressed/attenuated and minimized.

The modified bus bar system may be designed to guarantee maximal attenuation of magnetic fields emanating from its various elements by ensuring that the following condition is met for all magnetic moments Mᵢ and dipoles Pᵢ:

$${\sum }_{i = 1}^{N} {\overline{\dot{M}}}_{i} = 0 , {\sum }_{i = 1}^{N} {\overline{\dot{P}}}_{i} = 0 , \qquad ( 1 )$$

where N is a positive integer indicating the total number of magnetic emanating elements (e.g., bus bar or sub-bus-bar elements), and i is an integer index indicating a particular dipole/moment of a specific bus bar or sub-bus-bar element. Accordingly, the location, cross-sectional area, geometrical arrangement and/or connectivity of each electricity carrying element of the power distribution unit may be modified in order to meet the conditions set in equation (1).

In one broad aspect the present invention provides a power distribution unit, comprising a bus bar system connectable to an electric power feed line and comprising for each specific electric phase or current direction of the feed line at least two bus bar elements electrically connected to each other, said bus bar elements are arranged one parallel to the other and may be aligned such that each element is situated adjacent at least one other element carrying electric current associated with a different phase or current direction, and socket outlets each electrically connected to said bus bar elements.

According to one aspect there is provided a power distribution unit comprising a bus bar system connectable to an electric power feed line and comprising at least two bus bar elements electrically connected to each other and associated with an electric phase of the feed line and at least two bus bar elements electrically connected to each other and associated with an electric neutral of the feed line, the bus bar elements arranged one parallel to the other such that each element is situated adjacent at least one element carrying electric current of a different phase or current direction. The power distribution unit further comprises socket outlets electrically connected to at least one bus bar element associated with the electric phase and to at least one bus bar element electrically connected to the electric ground.

In some applications the power distribution unit comprises a bus bar element associated with an electric ground of the feed line, where the socket outlets are further electrically connected to the ground bus bar element.

In some embodiment the bus bar elements are arranged substantially in the same geometric plane. For example, and without being limiting, the bus bar elements associated with the electric phase and with the electric neutral may be arranged in an intervening fashion in the same geometric plane, wherein the ground bus bar element is situated at a center of the bus bar arrangement (e.g., in parallel to the other bus bar elements). Alternatively, the ground bus bar element may be situated anywhere adjacent (e.g., on top, or at bottom) to the other bus bar elements.

In some possible embodiments the bus bar elements are arranged in two substantially parallel geometric planes. For example, and without being limiting, the power distribution unit may comprise two bus bar elements associated with the electric phase and two bus bar elements associated with the electric neutral. In such an application the bus bar elements may be arranged such that one bus bar element associated with the electric phase and one bus bar element associated with the electric neutral are arranged in parallel in a first geometric plane (e.g., with the ground bus bar situated between them), and one other bus bar element associated with the electric phase and one other bus bar element associated with the electric neutral are arranged in parallel in a second geometric plane, said geometric planes being substantially parallel one to the other.

As another non-limiting example, the bus bar elements may be arranged such that the two bus bar elements associated with the electric phase are arranged in parallel in a first geometric plane, and the two bus bar elements associated with the electric neutral are arranged in parallel in a second geometric plane being substantially parallel to the first geometric plane, such that at least one bus bar element is situated above a midpoint between two bus bar elements situated in the other geometric plane and carrying electric currents associated with a different phase or current direction.

In possible implementations, the power distribution unit comprises a ground bus bar situated between bus bar elements arranged in one of the geometric planes. Alternatively, the ground bus bar may be situated adjacent (e.g., in parallel) bus bar elements arranged in one of the geometric planes.

According to another aspect there is provided a method for suppressing/attenuating magnetic fields emanating from a bus bar system, the method comprising using two or more sub-bus-bar elements to implement each bus bar element of the bus bar system, cross sectional areas of the two or more sub-bus-bar elements associated with a specific bus bar element are set so as to guarantee uniform distribution of electrical current associated with said specific bus bar element between said two or more sub-bus-bar elements, arranging the sub-bus-bar elements in parallel to each other and in an intervening fashion such that each sub-bus-bar element is located adjacent at least one other sub-bus-bar element associated with an electric current of a different phase or direction, and electrically connecting sub-bus-bar elements associated with a specific phase or direction of electric current between themselves.

In some embodiments the sub-bus-bar elements are aligned in the same geometric plane. Alternatively, the sub-bus-bar elements may be uniformly distributed in an intervening fashion in a defined volume.

According to yet another aspect there is provided a method for modifying a power distribution unit, comprising placing at least one sub-bus-bar element in parallel to each bus bar element of the power distribution unit associated with a specific phase or direction of electric current, and electrically connecting between the at least one sub-bus-bar element and the bus bar element associated with the same specific phase or direction of electric current. The method may comprise connecting one or more sockets to the sub-bus-bar elements.

### BRIEF DESCRIPTION OF THE DRAWINGS

In order to understand the invention and to see how it may be carried out in practice, embodiments will now be described, by way of non-limiting example only, with reference to the accompanying drawings. Features shown in the drawings are meant to be illustrative of only some embodiments of the invention, unless otherwise implicitly indicated. In the drawings, like reference numerals are used to indicate corresponding parts, and in which:

FIGS. 1A and 1B schematically illustrate conventional arrangements of power distribution units, where FIG. 1A is a perspective view of the power distribution unit, and FIG. 1B is a side view of the bus bar system of the unit;

FIG. 2 is a flowchart exemplifying a method of modifying a bus bar system of a power distribution box according to some possible embodiments;

FIGS. 3A to 3D schematically illustrate possible arrangements for suppressing magnetic fields emanating from a power distribution unit according to some possible embodiments, wherein FIG. 3A shows a top view of a possible unit arrangement, FIG. 3B shows a side view of the bus bar system, in which elements are arranged aligned in the same geometric plane, FIG. 3C exemplifies a variable connectivity scheme of the outlet sockets to the bus bar system, and FIG. 3D is a side view of a bus bar system in which elements are arranged in two parallel geometric planes; and

FIGS. 4A to 4C schematically illustrate other bus bar element arrangements according to possible embodiments wherein FIG. 4A is a top view of a possible power distribution unit arrangement, FIG. 4B shows a side view of a bus bar system, in which elements are arranged aligned in the same plane, and FIG. 4C is a side view of a bus bar system, in which elements are arranged in two parallel geometric planes.

### DETAILED DESCRIPTION OF EMBODIMENTS

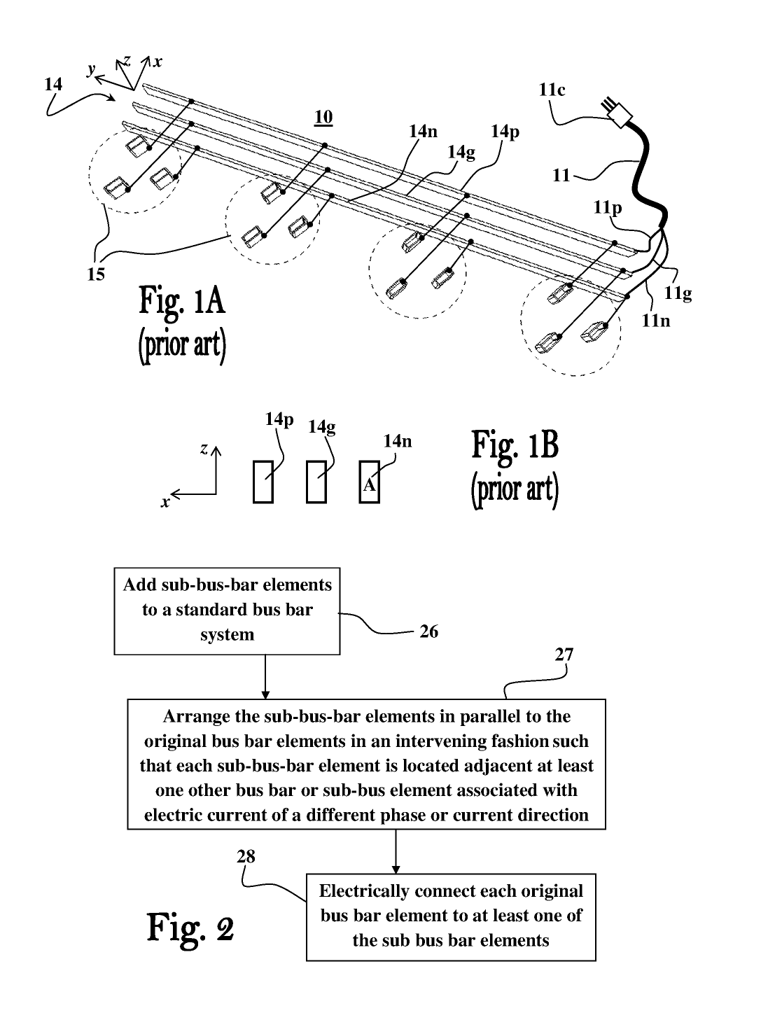

The various embodiments of the present invention are described below with reference to FIGS. 1 through 4 of the drawings, which are to be considered in all aspects as illustrative only and not restrictive in any manner. Elements illustrated in the drawings are not necessarily to scale, emphasis instead being placed upon clearly illustrating the principles of the invention. This invention may be provided in other specific forms and embodiments without departing from the essential characteristics described herein.

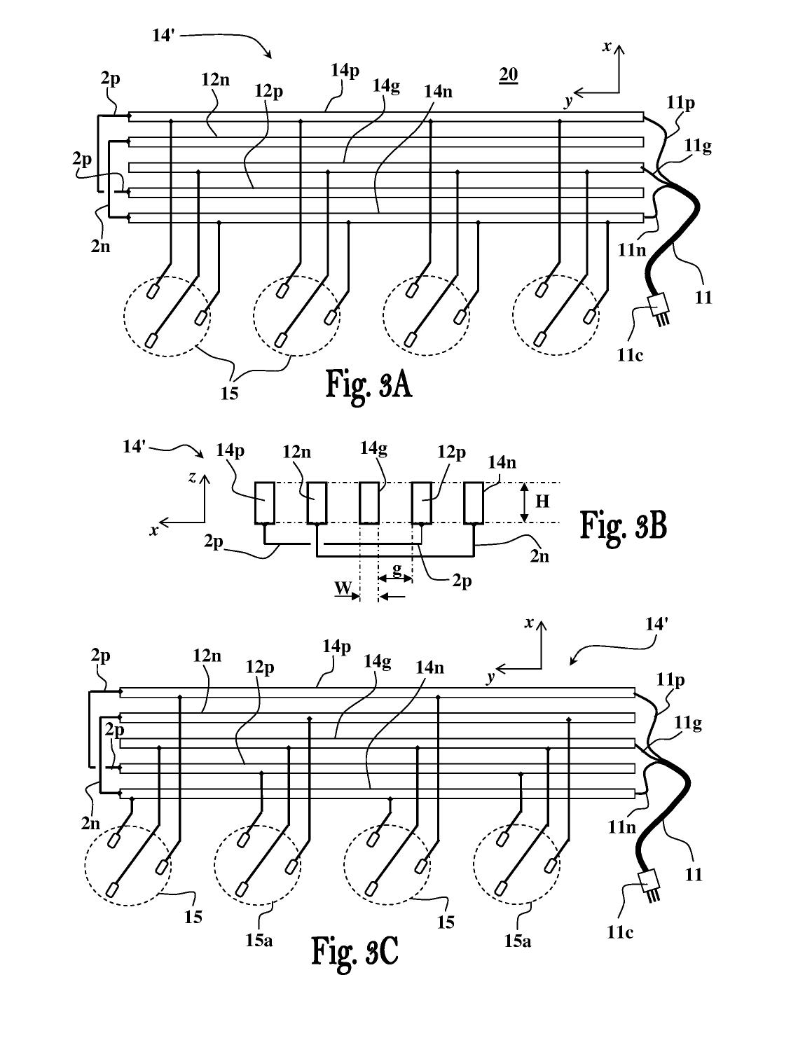

The present invention provides designs and arrangements for substantially suppressing intensity of magnetic fields emanating from electrical power distribution units. With reference to FIG. 2, in some embodiments the intensity of magnetic fields emanating from conventional power distribution units is substantially suppressed by adding sub-bus-bar elements to the standard bus bar system of the power distribution box (26), arranging the sub-bus-bar elements in parallel to the original bus bar elements of the bus bar system in an intervening fashion (27) such that each sub-bus-bar element is located adjacent at least one bus bar or sub-bus element associated with electric current of a different phase or current direction, electrically connecting each one of the original bus bar elements to at least one of the sub-bus-bar elements (28). Such an intervening arrangement of bus bar and sub-bus-bar elements provides that the magnetic fields emanating from the different bus bar and sub-bus-bar elements destructively interfere with each other. As will be discussed and demonstrated hereinbelow, various different arrangements of the bus bar system may be utilized to obtain bus bar system structures in which the magnetic fields emanating from the elements of the bus bar system destructively interfere with each other.

In some embodiments a bus bar system is constructed using at least two sub-bus-bar elements electrically connected to each other to implement the bus bar carrying the electric phase of the system, and at least two sub-bus-bar elements electrically connected to each other to implement the bus bar carrying the electric neutral of the system. The sub-bus-bar elements are arranged in parallel to each other such that each sub-bus-bar element is situated adjacent at least one other sub-bus-bar element associated with a different electric phase or current direction.

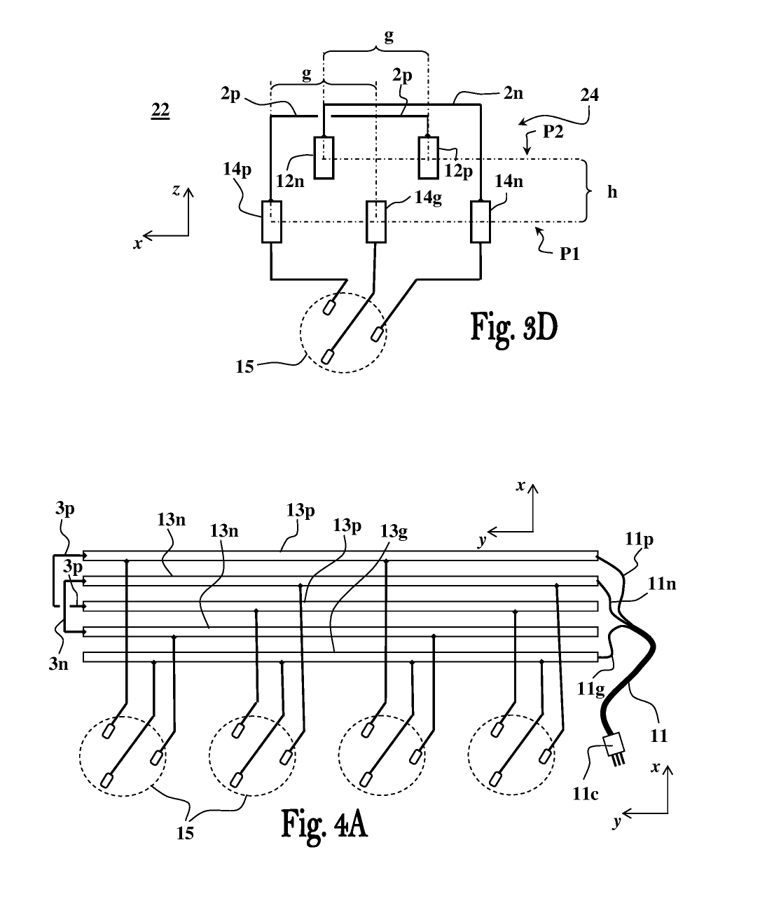

In the power distribution unit 20 exemplified in FIGS. 3A and 3B, for example, the standard bus bar system 14 shown in FIGS. 1A and 1B is modified by adding two sub-bus-bar elements, 12p and 12n, to the original bus bar system including the bus bar elements 14p, 14g and 14n. In this example the newly added sub-bus-bar element 12n is placed between the bus bar element 14p carrying the electric phase in the original bus bar system 14 and the bus bar element 14g carrying the electric ground in the original bus bar system 14, and the newly added sub-bus-bar element 12p is placed between the bus bar element 14g carrying the electric ground in the original bus bar system 14 and the bus bar element 14n carrying the electric neutral in the original bus bar system 14. An electrically conducting wire (jumper) 2p is used to electrically connect between the original bus bar element 14p carrying the electric phase and the newly added sub-bus-bar element 12p, and another conducting wire (jumper) 2n is used to electrically connect between the newly added sub-bus-bar element 12n and the original bus bar element 14n carrying the electric neutral.

As seen, in this arrangement each element of the modified bus bar system 14′ is positioned in parallel to, and adjacent, at least one other element associated with electrical current of a different phase or current direction. For example, the bus bar element 14p carrying the electric phase is positioned adjacent and parallel to sub-bus-bar element 12n electrically connected to the electrical neutral, the sub-bus-bar element 12n electrically connected to the electric neutral is positioned in parallel and adjacent to bar elements 14p and 12p electrically connected to the electrical phase of the system, and the bus bar element 14n carrying the electric neutral is positioned adjacent and parallel to sub-bus-bar element 12p electrically connected to the electrical phase. The modified bus bar system 14′ is electrically connected to the electric power feed line 11 by the wires 11p, 11g and 11n, connecting the electric phase, ground and neutral of the feed line 11 to the respective bus bar elements 14p, 14g and 14n.

FIG. 3B shows a side view of the modified bus bar system 14′. As seen, the bus bar elements 14p, 14g and 14n of the original bus bar system 14, and the newly added sub-bus-bar elements 12n and 12p, are aligned in the same geometric plane (i.e., the x-y plane), in an intervening fashion. The bus bar and sub-bus-bar elements are typically elongated electrically conducting elements (e.g., made from copper or bronze). The height H and width W of the bus bar and sub-bus-bar elements may generally be set according to the standards adopted in each country. The gap g between adjacent elements may generally be also set according to customary standards. Optionally, and in some embodiments preferably, the gap g is made as small as possible to improve magnetic field reduction to the standard requirements level. Cross sections of the bus bar and sub-bus-bar elements should be properly set to guarantee symmetric distribution of the electrical current therein e.g., by using bus bar and sub-bus-bar elements having substantially the same cross-sectional area.

In the example shown in FIG. 3A the socket outlets 15 are electrically connected to the original bus bar elements 14p, 14g and 14n (i.e., of bus bar system 10 shown in FIG. 1), of the power distribution unit 20, thereby maintaining their original connection before the bus bar system 14 has been modified. FIG. 3C exemplifies another possible embodiment wherein the connectivity of the socket outlets is also modified such that at least some of the socket outlets 15a are electrically connected to the newly added sub-bus-bar elements 12p and 12n. More particularly, FIG. 3C exemplifies electrical connection of four socket outlets, including two socket outlets 15 electrically connected to the original bus bar elements 14p, 14g and 14n, and two socket outlets 15a electrically connected to the newly added sub-bus-bar elements 12p and 12n. Of course various different arrangements are also possible, but it is generally preferable that at least one, or some, of the socket outlets be electrically connected to the newly added sub-bus-bar elements 12p and 12n, and at least some other to the original bus bar elements 14p, 14g and 14n, in any suitable order (e.g., in alternating order, as exemplified in FIG. 3C).

It is noted that all of the socket outlets 15 and 15a are electrically connected in this example to the bus bar element 14g carrying the electrical ground of the system. In some possible embodiments the bus bar element 14g associated with the electrical ground of the system may be also implemented by two or more sub-bus-elements electrically connected to each other and arranged in parallel to the other bus bar and sub-bus-bar elements. However, the electrical elements associated with the electrical ground of the system usually do not carry substantial electrical currents during normal operation of the power distribution units, such that splitting the ground bus bar element into two or more sub-bus-bar elements usually does not substantially improve suppression of the intensity of the magnetic field.

FIG. 3D demonstrates another possible arrangement of the elements of a bus bar system 24 of a power distribution unit 22 according to some possible embodiments. In this example, the original bus bar elements 14p, 14g and 14n, are arranged aligned in the same geometrical plane P1 (i.e., the x-y plane), as in FIG. 1B, and the newly added sub-bus-bar elements 12n and 12p, are located in another geometric plane P2 substantially parallel above or below the geometric plane P1 of the original bus bar elements 14p, 14g and 14n. Conducting wires 2p and 2n are used to electrically connect the sub-bus-bar element 12p to the bus bar element 14p, and the sub-bus-bar element 12n to the bus bar element 14n, respectively. Accordingly, this arrangement provides that each bus bar and sub-bus-bar element is positioned in the bus bar system adjacent at least one other bus bar or sub-bus-bar element associated with electric current of a different phase or current direction.

More particularly, the sub-bus-bar element 12n electrically connected to the electric neutral of the system is positioned adjacent the bus bar element 14p carrying the electric phase of the system and adjacent sub-bus-bar element 12p electrically connected to the electric phase of the system, and the sub-bus-bar element 12p electrically connected to the electric phase of the system is positioned adjacent the bus bar element 14n carrying the electric neutral of the system and adjacent sub-bus-bar element 12n electrically connected to the electric neutral of the system. In this way the magnetic fields emanating from the bar elements associated with the electric phase and with the electric neutral of the system 24 destructively interfere with each other, such that the overall intensity of the magnetic field emanating from the bus bar system 24 is substantially suppressed.

For example and without being limiting, the sub-bus-bar element 12n may be placed above a midpoint between the bus bar element 14p carrying the electric phase and the bus bar element 14g carrying the electric ground, and the sub-bus-bar element 12p may be placed above a midpoint between the bus bar element 14n carrying the electric neutral and the bus bar element 14g carrying the electric ground. Thus, in some embodiments the bar elements may be arranged to form a trapezoid sectional shape, where the smaller base of the trapezoid is formed by the newly added sub-bus-bar elements 12n and 12p respectively carrying the electric neutral and phase of the bus system 24, and the large base of the trapezoid is formed by the bus bar elements 14p and 14n respectively carrying the electric phase and neutral of the bus system 24, and wherein the bus bar element 14g carrying the ground is positioned at the center of the large base of the trapezoid.

FIG. 3D exemplifies connecting the outlet sockets 15 to original bus bar elements 14p, 14g an 14n, arranged in the first geometric plane P1. In some possible embodiments the socket outlets 15 may be electrically connected to the sub-bus-bar elements 12n and 12p. Optionally, the socket outlet connection to the bus bar system is changed in an alternate fashion, between the bar elements located in the two geometric planes e.g., socket outlets electrically connected to the bus bar element 14p and 14n situated in the first geometric plane P1 are followed by socket outlets electrically connected to the bus bar element 12p and 12n situated in the second geometric plane P2.

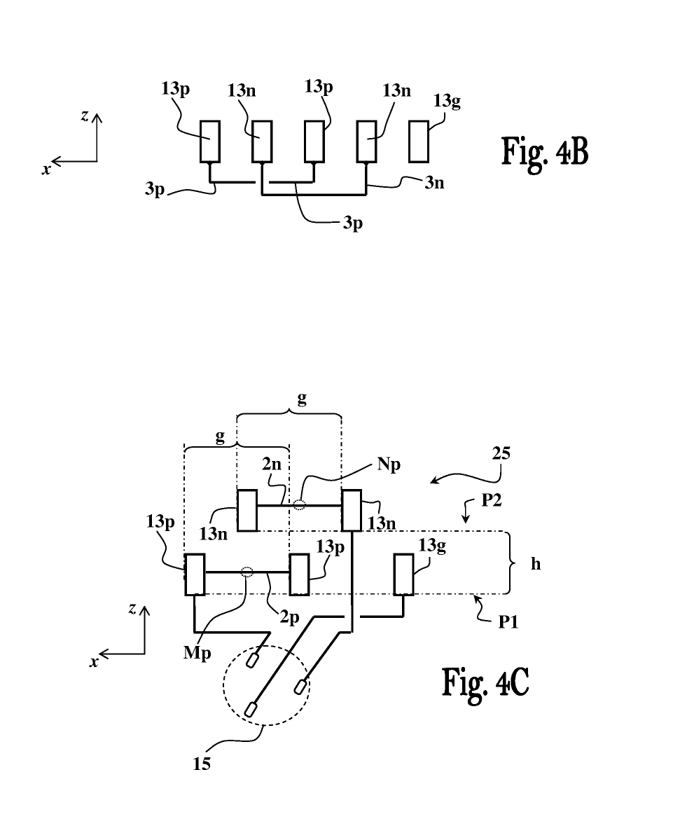

In the different arrangements exemplified in FIGS. 3A to 3D the bus bar element 14g carrying the electric ground of the system is located substantially at the center of the bus bar system, or substantially centered between the bar elements located in one of the geometric planes. FIGS. 4A to 4C exemplify embodiments in which the bus bar element 13g carrying the electric ground of the system is situated lateral to the other bus bar elements of the bus bar system. With reference to FIG. 4A, in some embodiments each one of the original bus bar elements associated with the electric phase or electric neutral of the system is split into two or more sub-bus-bar elements, and the sub-bus-bar elements are situated substantially aligned in the same plane and in parallel one to the other such that each sub-bus-bar element is placed adjacent to at least one other sub-bus-bar element associated with an electric current of a different phase or current direction. For example, the sub-bus-bar elements associated with the electric phase of the system and the sub-bus-bar elements associated with the electric neutral of the system may be arranged in an intervening fashion substantially in parallel one to the other and in the same geometric plane, and the bus bar elements associated with the electric ground can be placed substantially lateral and parallel to the intervening arrangement of the sub-bus-bar elements associated with the electric phase and neutral of the system.

In FIG. 4A, the bus bar element associated with the electric phase (e.g., 14p in FIGS. 1A and 1B) is split into two sub-bus-bar elements 13p electrically connected to each other by conducting wire 3p, and the bus bar element associated with the electric neutral (e.g., 14n in FIGS. 1A and 1B) is split into two sub-bus-bar elements 13n electrically connected to each other by conducting wire 3n. The sub-bus-bar elements 13p and 13n are arranged in an intervening fashion substantially in the same geometric plane (i.e., in the x-y plane) and substantially parallel one to the other. In this way each sub-bus-bar element 13p associated with the electric phase of the system is situated adjacent at least one sub-bus-bar element 13n associated with the electrical neutral of the system. As seen in the side view shown in FIG. 4B, the bus bar element 13g associated with the electric ground of the system is situated substantially parallel and lateral to the sub-bus-bar elements 13p and 13n.

It is noted that the splitting of the bus bar elements of the power distribution unit exemplified in FIG. 4A-B may be similarly used to implement the bus bar system shown in FIGS. 3A-D. In such embodiments employing sub-bus-bar element the cross sectional area A of the original bar elements (14n in FIG. 1) may be reduced (e.g., to about A/n where n in an integer number indicating the number of sub-bus-bar elements into which each bus bar element is being split) according to the number (n) of sub-bus-bar elements (12) used to implement each of the original bus bar elements (14).

FIG. 4C demonstrates another possible embodiment 25 wherein the bus bar element 13g associated with the electric ground of the system is situated lateral to the sub-bus-bar elements of the system, and wherein the sub-bus-bar elements are arranged in two substantially parallel geometric planes. More particularly, the sub-bus-bar elements 13p associated with the electric phase of the system 25 are arranged one parallel to the other in substantially the same geometric plane P1 (i.e., the x-y plane), and the sub-bus-bar elements 13n associated with the electric neutral of the system 25 are arranged one parallel to the other in another geometric plane P2 substantially parallel (above or below) to the geometric plane P1 of the sub-bus-bar elements 13p. The sub-bus-bar elements 13p and 13n are respectively arranged in the two parallel geometric planes P1 and P2 to provide an intervening configuration such that at least one sub-bus-bar element in each plane is situated above/below a midpoint between two bar elements in the other geometric plane, which are associated with electrical current of a different phase or current direction.

More particularly, in FIG. 4C at least one of the sub-bus-bar elements 13n associated with the electric neutral of the bus system 25 is situated adjacent and above a midpoint Mp between the two sub-bus-bar elements 13p associated with the electric phase of the bus system 25, and at least one of the sub-bus-bar elements 13p associated with the electric phase of the bus system 25 is situated adjacent and below a midpoint Np between two sub-bus-bar elements 13n associated with the electric neutral of the bus system 25. Thus, in this arrangement, each of the sub-bus-bar elements is situated adjacent at least one other sub-bus-bar element associated with a different phase or current direction. In this example the sub-bus-bar elements arrangement forms a trapezoid sectional shape, where the smaller base of the trapezoid is formed by the sub-bus-bar elements 13n carrying the electric neutral of the bus system 25, and the large base of the trapezoid is formed by one of the sub-bus-bar elements 13p carrying the electric phase of the bus system 25 and the sub-bus-bar elements 13g carrying the electric ground of the bus system 25, and wherein the other sub-bus-bar element 13p carrying the electric phase of the bus system 25 is positioned at the center of the large base of the trapezoid.

An electrically conducting wire 2n is used to electrically connect between the sub-bus-bar elements 13n associated with the electric neutral of the system and situated in the upper geometric plane P2, and another electrically conducting wire 2p is used to electrically connect between the sub-bus-bar elements 13p associated with the electric phase of the system and situated in the bottom geometric plane P1.

While the bus bar element 13g associated with the electric ground is situated in FIG. 4C in the geometric plane P1 of the sub-bus-bar elements 13p associated with the electric phase of the system, it may be similarly located in the other geometric plane P2 in which the sub-bus-bar elements 13n associated with the electric neutral of the system are situated. Optionally, the bus bar element 13g may be split into two sub-bus-bar elements (e.g., each having a cross sectional area of about half of the cross sectional area of the original bus bar element 13g), where each sub-bus-bar element is situated in one of the planes P1 and P2 parallel and adjacent to the other sub-bus-bar elements.

The distance g between each pair of sub-bus-bar elements associated with the same electric current direction (or phase) and situated in the same geometric plane is substantially the same. The distance h between the geometric planes in which the elements associated with the electric phase and neutral of the system is made as small as possible, and may generally be set to comply with customary standards.

The above examples and description have of course been provided only for the purpose of illustration, and are not intended to limit the invention in any way. As will be appreciated by the skilled person, the invention can be carried out in a great variety of ways, employing more than one technique from those described above, all without exceeding the scope of the invention.

1-16. (canceled)

17. A power distribution unit, comprising;
a bus bar system connectable to an electric power feed line, the bus bar system including for each specific electric phase or current direction of the electric power feed line at least two bus bar elements electrically connected to each other, the at least two bus bar elements arranged substantially parallel to each other such that each of the at least two bus bar elements is situated adjacent to at least one other of the at least two bus bar elements carrying electric current associated with a different phase or current direction; and
socket outlets each of which is electrically connected to the at least two bus bar elements.

18. The power distribution unit of claim 17, wherein the at least two bus bar elements include at least two bus bar elements associated with an electrical phase of the electric power feed line and at least two bus bar elements associated with an electric neutral of the feed line.

19. The power distribution unit of claim 17, wherein the at least two bus bar elements include a ground bus bar element associated with an electric ground of the electric power feed line, the socket outlets being electrically connected to the ground bus bar element.

20. The power distribution unit of claim 19, wherein the at least two bus bar elements are arranged substantially in the same geometric plane.

21. The power distribution unit of claim 20, wherein the at least two bus bar elements associated with the electric phase and the at least two bus bar elements associated with the electric neutral are arranged in an intervening fashion, wherein the ground bus bar element is situated generally at a center of the bus bar arrangement.

22. The power distribution unit of claim 18, wherein the at least two bus bar elements are arranged in two substantially parallel geometric planes.

23. The power distribution unit of claim 22, wherein the at least two bus bar elements include two bus bar elements associated with the electric phase and two bus bar elements associated with the electric neutral.

24. The power distribution unit of claim 23, wherein the at least two bus bar elements are arranged such that one of the at least two bus bar elements is associated with the electric phase and one of the at least two bus bar elements is associated with the electric neutral are arranged substantially parallel in a first geometric plane, and one of the at least two bus bar elements is associated with the electric phase and one of the at least two bus bar elements is associated with the electric neutral are arranged substantially parallel in a second geometric plane, the geometric planes being substantially parallel one to the other.

25. The power distribution unit of claim 24, wherein the at least two bus bar elements include a ground bus bar situated between the at least two bus bar elements arranged in one of the geometric planes.

26. The power distribution unit of claim 24, wherein the at least two bus bar elements include a ground bus bar situated adjacent bus bar elements arranged in one of the geometric planes.

27. The power distribution unit of claim 23, wherein the at least two bus bar elements are arranged such that the two bus bar elements associated with the electric phase are arranged substantially parallel in a first geometric plane, and the two bus bar elements is associated with the electric neutral are arranged substantially parallel in a second geometric plane being substantially parallel to the first geometric plane, such that at least one of the bus bar elements is situated above a midpoint between two bus bar elements situated in the other geometric plane and carrying electric current associated with a different phase or current direction.

28. A method for suppressing magnetic fields emanating from a bus bar system, the method comprising:
using two or more sub-bus-bar elements to implement each bus bar element of the bus bar system, cross sectional areas of the two or more sub-bus-bar elements associated with a specific bus bar element are set to substantially uniformly distribute electrical current associated with the specific bus bar element between the two or more sub-bus-bar elements;
arranging the sub-bus-bar elements substantially parallel to each other and in an intervening fashion such that each sub-bus-bar element is located adjacent at least one other sub-bus-bar element associated with an electric current of a different phase or direction; and
electrically connecting the sub-bus-bar elements associated with a certain phase or direction of electric current between themselves.

29. The method according to claim 28, further comprising arranging the sub-bus-bar elements aligned in the same geometric plane.

30. The method according to claim 28, further comprising substantially uniformly distributing the sub-bus-bar elements in an intervening fashion in a defined volume.

31. A method for modifying a power distribution unit, the method comprising:
placing at least one sub-bus-bar element substantially parallel to each bus bar element of the power distribution unit associated with a specific phase or direction of electric current; and
electrically connecting between the at least one sub-bus-bar element and the bus bar element associated with same specific phase or direction of electric current.

32. The method according to claim 31, further comprising connecting one or more sockets to the at least one sub-bus-bar element.

33. The method according to claim 29, further comprising placing a ground bus bar element at a center of the bus bar arrangement.

34. The method according to claim 30, further comprising arranging the sub-bus-bar elements in two substantially parallel geometric planes.

35. The method according to claim 34, further comprising placing a ground bus bar element adjacent bus bar elements arranged in one of the geometric planes.

36. The method according to claim 34, further placing a ground bus bar element at a center of the bus bar elements arranged in one of the geometric planes.
